(19) United States
(12) Patent Application Publication
(10) Pub. No.: US 2020/0410280 A1
(43) Pub. Date: Dec. 31, 2020

(54) METHODS AND APPARATUSES FOR UPDATING DATABASES, ELECTRONIC DEVICES AND COMPUTER STORAGE MEDIUMS

(71) Applicant: BEIJING SENSETIME TECHNOLOGY DEVELOPMENT CO., LTD., Beijing (CN)

(72) Inventors: Wei WU, Beijing (CN); Bo LI, Beijing (CN); Chengwei GU, Beijing (CN)

(21) Appl. No.: 17/019,827

(22) Filed: Sep. 14, 2020

Related U.S. Application Data
(63) Continuation of application No. PCT/CN2019/092422, filed on Jun. 21, 2019.

(30) Foreign Application Priority Data
Nov. 1, 2018 (CN) 201811296559.8

(51) Int. Cl. G06K 9/62; G06T 5/50; G06K 9/00

(52) U.S. Cl. CPC G06K 9/6202; G06T 5/50; G06K 9/00288; G06K 9/6232; G06K 9/6215

(57) ABSTRACT

Provided are a method and an apparatus for updating a database, an electronic device, and a computer storage medium. The method for updating a database includes: searching (110) a plurality of reference image templates included in a first database for at least two reference image templates matching with an image of a target object; and updating (120) the first database based on similarities of the at least two reference image templates with the image.

### CROSS-REFERENCE TO RELATED APPLICATIONS

This application is a continuation of International Application No. PCT/CN2019/092422, filed on Jun. 21, 2019, which claims priority to Chinese patent application No. 201811296559.8, filed on Nov. 1, 2018. The content of International Application No. PCT/CN2019/092422 and Chinese patent application No. 201811296559.8 are hereby incorporated by reference in their entireties.

### TECHNICAL FIELD

Embodiments of the disclosure relate to computer vision technologies, and particularly to a method and an apparatus for updating a database, an electronic device and a computer storage medium.

### BACKGROUND

With development of computer vision technologies, image recognition is applied to various industries such as security monitoring, facial unlocking and smart retail. During implementation of image-based facial recognition, a plurality of facial image templates are prestored in a database, and identity recognition is performed on an acquired facial image based on the database. With expansion of application scenarios of image-based identity recognition, the number of faces to be recognized is continuously increased, and thus an actual application demand cannot be satisfied with a database prestored with a fixed number of facial image templates.

### SUMMARY

Embodiments of the application provide a database update technology.

According to one aspect of the embodiments of the disclosure, provided is a computer-implemented method for updating a database, including: searching a plurality of reference image templates in a first database for at least two reference image templates matching with an image of a target object; and updating the first database based on similarities of the at least two reference image templates with the image.

According to another aspect of the embodiments of the disclosure, provided is an apparatus for updating a database, including: a search unit, configured to search a plurality of reference image templates in a first database for at least two reference image templates matching with an image of a target object; and a database update unit, configured to update the first database based on similarities of the at least two reference image templates with the image.

According to still another aspect of the embodiments of the disclosure, provided is an apparatus for updating a database, including: a processor; and a memory configured to store instructions which, when being executed by the processor, cause the processor to carry out the following: searching a plurality of reference image templates in a first database for at least two reference image templates matching with an image of a target object; and updating the first database based on similarities of the at least two reference image templates with the image.

According to still another aspect of the embodiments of the disclosure, provided is a non-transitory computer-readable storage medium having stored thereon computer programs that, when being executed by a computer, cause the computer to carry out the following: searching a plurality of reference image templates in a first database for at least two reference image templates matching with an image of a target object; and updating the first database based on similarities of the at least two reference image templates with the image

The technical solutions of the disclosure will further be described below in detail through the accompanying drawings and the embodiments.

### BRIEF DESCRIPTION OF THE DRAWINGS

The drawings forming a part of the specification describe the embodiments of the disclosure and, together with the descriptions, serve to explain the principle of the application.

Referring to the drawings, the disclosure may be understood more clearly according to the following detailed description.

FIG. 1 illustrates a schematic flowchart of a method for updating a database according to an embodiment of the disclosure.

FIG. 2 illustrates another schematic flowchart of the method for updating a database according to an embodiment of the disclosure.

FIG. 3 illustrates still another schematic flowchart of the method for updating a database according to an embodiment of the disclosure.

FIG. 4A illustrates a schematic flowchart of updating at least a subset of at least two reference image templates in a first database in the method for updating a database according to an embodiment of the disclosure.

FIG. 4B illustrates a further schematic flowchart of the method for updating a database according to an embodiment of the disclosure.

FIG. 5 illustrates a schematic flowchart of updating a first database in the method for updating a database according to an embodiment of the disclosure.

FIG. 6 illustrates a structural schematic diagram of an apparatus for updating a database according to an embodiment of the disclosure.

FIG. 7 illustrates a structural schematic diagram of an electronic device according to an embodiment of the disclosure.

### DETAILED DESCRIPTION

Exemplary embodiments of the disclosure will now be described with reference to the drawings in detail. It is to be noted that relative arrangement of components and steps, numeric expressions and numeric values elaborated in these embodiments do not limit the scope of the disclosure, unless otherwise indicated specifically. In addition, it is to be understood that, for convenient description, the size of each part shown in the drawings is not drawn according to practical proportions. The following descriptions of at least one exemplary embodiment are merely illustrative in fact and are not intended to form any limit to the disclosure and application or use thereof. Technologies, methods and devices known to those of ordinary skill in the art may not be discussed in detail, but the technologies, the methods and the devices should be considered as a part of the specification as appropriate. It is to be noted that similar reference signs and letters represent similar items in the following drawings and thus a certain item, once defined in a drawing, does not have to be further discussed in subsequent drawings.

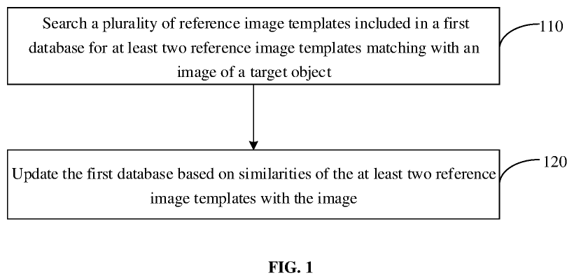

FIG. 1 illustrates a schematic flowchart of a method for updating a database according to an embodiment of the disclosure. The method may be executed by any electronic device, such as a terminal device, a server, or a mobile device.

In operation 110, a plurality of reference image templates in a first database are searched for at least two reference image templates matching with an image of a target object.

In embodiments of the disclosure, an image of a target object is acquired. For example, the image of the target object input by a user is received, or the image of the target object is acquired with an image sensor, or the image of the target object is received from other devices. The target object may be a person, a face, a specific article or other objects. The image of the target object may refer to an image containing at least a part of the target object, such as a face image, a half-length portrait or a human body image. The image of the target object may be a static image or a video frame image. For example, the image of the target object may be a video frame image, such as an image frame in a video sequence originating from an image sensor, or may be a single image. The particular implementations of attributes, origins, means of acquisition or the like for the image of the target object are not limited in embodiments of the disclosure.

A plurality of reference image templates are stored in the first database. For example, a reference image template stored in the first database may include an image and/or feature data. The feature data includes, but not limited to, a feature vector, a feature map or the like. The reference image template may further include other information. The reference image template may be entered manually, or acquired from other devices, or dynamically generated during image/video processing. For example, the reference image template may be generated during registration of a user, during processing of a video acquired in real time or the like. The particular implementations of the origin of the reference image template and information included in the reference image template are not limited in embodiments of the disclosure.

In operation 110, the first database is searched to determine whether the first database contains a reference image template matching with the image of the target object. A search result obtained by searching includes at least two reference image templates matching with the image of the target object. For example, a similarity of the image of the target object with a reference image template may be determined, and whether the image of the target object matches with the reference image template is determined based on the similarity.

In some implementations, a similarity threshold may be provided, and whether the image of the target object matches with a reference image template may be determined by comparing a similarity between the reference image template and the image of the target object to the similarity threshold. For example, similarities of the image of the target object with a plurality of reference image templates included in the first database are determined, where the similarities may be those between the image of the target object with a subset or all of the plurality of reference image templates; at least two reference image templates are obtained from the plurality of reference image templates based on the similarity threshold, where each of the at least two reference image templates has a similarity with the image of the target object greater than the similarity threshold; and the obtained at least two reference image templates are taken as reference image templates matching with the image of the target object.

In some other implementations, a reference image template matching with the image of the target object may be determined based on comparing values of similarities between the image of the target object and the plurality of reference image templates. For example, the plurality of reference image templates are sorted in a descending order of the similarities of the plurality of reference image templates with the image of the target object, and the first k of the plurality of sorted reference image templates are taken as a search result, k being a preset integer greater than or equal to 1.

In some other implementations, a reference image template matching with the image of the target object may be determined in combination of the above two implementations. That is, the first k of the at least two reference image templates are selected as a search result, where each of the at least two reference image templates has a similarity with the image of the target object greater than the similarity threshold.

A reference image template matching with the image of the target object may also be determined in other ways.

In embodiments of the disclosure, a similarity of the image of the target object with a reference image template may be determined in a variety of manners. For example, the image of the target object and the reference image templates may be input into a neural network for processing, and indication of whether the image of the target object matches with the reference image template is output. For another example, whether the image of the target object matches with a reference image template is determined based on a distance from feature data of the image of the target object to feature data corresponding to the reference image template, and so on, which is not limited in embodiments of the disclosure.

In some implementations, a reference image template includes an image but not feature data. In this case, feature extraction may be first performed on the image included in the reference image template and the image of the target object, respectively, to obtain feature data of the reference image template and image feature data of the image of the target object. Whether the reference image template matches with the image of the target object is determined based on a distance between the feature data of the reference image template and the image feature data.

In some other implementations, a reference image template includes feature data. In this case, feature extraction may be first performed on the image of the target object to obtain image feature data of the image of the target object. Whether the reference image template matches with the image of the target object is determined based on a distance between the image feature data of the image of the target object and the feature data included in the reference image template.

In some other implementations, other search means may be used to obtain reference image templates matching with the image of the target object, and the specific search manner is not limited in embodiments of the disclosure.

In operation 120, the first database is updated based on similarities of the at least two reference image templates with the image.

In some implementations, the update of the first database includes update of the at least two reference image templates in the first database. For example, data of a subset or all of the at least two reference image templates are adjusted. For another example, a subset of the at least two reference image templates are deleted. For another example, data of a first reference image template of the at least two reference image templates is adjusted, and at least one third reference image template of the at least two reference image templates is deleted, and the embodiments of the disclosure do not set limitations herein.

According to the method for updating a database provided in the embodiments of the disclosure, a plurality of reference image templates included in a first database are searched for at least two reference image templates matching with an image of a target object; and the first database is updated based on similarities of the at least two reference image templates with the image, thereby improving system performance of the database.

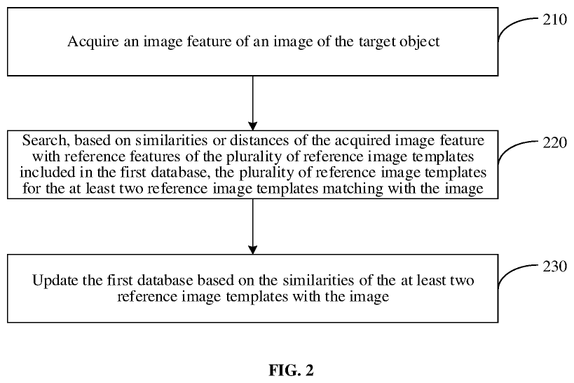

FIG. 2 illustrates another schematic flowchart of the method for updating a database according to an embodiment of the disclosure. Here, it is assumed that the reference image template includes feature data (referred to as a reference feature hereinafter), but embodiments of the disclosure are not limited thereto.

In 210, an image feature of the image of the target object is acquired.

The manner of acquiring the image feature includes, but not limited to: receiving the image feature of the target object from other devices, for example, receiving the image feature of an image from a terminal device (such as a mobile phone, a computer or a tablet computer); or acquiring (for example, acquiring with an image sensor or acquiring from other devices) the image and performing feature extraction processing on the image, etc. For example, the feature extraction processing on the image may be implemented through a convolutional neural network or other feature extraction algorithms, or other means may be used to perform feature extraction for the image. The specific manner of performing feature extraction for the image is not limited in the disclosure.

In 220, based on similarities or distances between the acquired image feature and reference features included in a plurality of reference image templates in a first database, the plurality of reference image templates are searched for at least two reference image templates matching with the image.

The similarity between the image feature and a reference feature depends on the distance between the image feature and the reference feature. The distance may include, but not limited to, a cosine distance, a Euclidean distance, a Mahalanobis distance or the like. The smaller the distance between the image feature and the reference feature is, the greater the similarity between the image feature and the reference feature is.

In some implementations, in the case where a similarity between the image feature and a reference feature reaches a preset condition, it may be considered that a reference image template to which the reference feature belongs matches with the image. The preset condition includes but not limited to: the similarity is greater than or equal to a similarity threshold, or the similarity is within a certain preset range, or the similarity ranks within a top preset number of all obtained similarities, etc. Besides the distance between the image feature and the reference feature, the similarity between the image feature and the reference feature may be determined based on other means. The particular implementations of determining the similarity between the image feature and the reference feature are not limited in embodiments of the disclosure.

In 230, the first database is updated based on similarities of the at least two reference image templates with the image.

In embodiments of the disclosure, a reference image template includes a reference feature. Since feature data occupies less storage space than images, and feature extraction is not needed for the stored data during search, a search speed is increased, and the data processing efficiency is improved.

As an example, a reference image template among the plurality of reference image templates, having a reference feature of which a similarity with the image feature reaches a first similarity threshold, is determined to be a reference image template matching with the image. That is, a similarity between a reference feature of each of the plurality of reference image templates and the image feature is determined, and a reference image template of which the similarity is greater than the first similarity threshold is determined as the reference image template matching with the image.

In order to obtain the reference image template matching with the image, a first similarity threshold is provided, and a reference image template of which the similarity is greater than or equal to the first similarity threshold is determined as the reference image template matching with the image. The magnitude of the first similarity threshold may be set according to particular conditions. For example, the first similarity threshold is set to 0.7, and the similarities of four reference image templates in the first database (i.e., reference image template 1, reference image template 2, reference image template 3 and reference image template 4) with the image are 0.6, 0.9, 0.7 and 0.3 respectively. In this case, by comparing the similarities with the first similarity threshold, reference image template 2 and reference image template 3 may be determined as reference image templates matching with the image. As another example, reference image templates corresponding to the first k highest similarities among the similarities of the reference features of the plurality of reference image templates with the image feature are determined as reference image templates matching with the image.

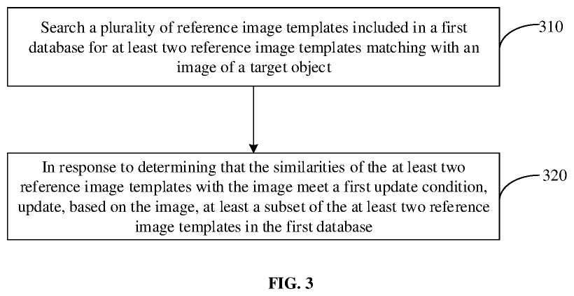

FIG. 3 illustrates still another schematic flowchart of the method for updating a database according to an embodiment of the disclosure.

In 310, a plurality of reference image templates included in a first database are searched for at least two reference image templates matching with the image of the target object. In 320, in response to determining that similarities of the at least two reference image templates with the image meet a first update condition, at least a subset of the at least two reference image templates stored in the first database are updated based on the image of the target object.

In embodiments of the disclosure, if at least one of the similarities of the at least two reference image templates with the image of the target object meets the first update condition, a subset or all of the at least two reference image templates included in a search result are updated based on the image of the target object. The update may refer to adjustment or deletion. For example, each of the at least two reference image templates included in the search result is updated based on the image of the target object, and the embodiments of the disclosure do not set limitations herein.

The first update condition is configured to determine whether to update the at least two reference image templates included in the search result.

In some implementations, the first update condition includes that: a minimum value among at least one similarity between the at least two reference image templates and the image of the target object reaches a specific similarity threshold; or, an average value of at least one similarity between the at least two reference image templates and the image of the target object reaches the specific similarity threshold; or, a maximum value of at least one similarity between at least one reference image template and the image of the target object reaches a specific similarity threshold, such as, for example, a second similarity threshold. That is to say, the first update condition is that a maximum value among the similarities of the at least two reference image templates with the image is greater than or equal to the second similarity threshold. The second similarity threshold is greater than the first similarity threshold. The particular implementations of the first update condition are not limited in embodiments of the disclosure.

In embodiments of the disclosure, a first database is searched firstly to obtain a search result corresponding to an image of a target object. Then whether similarities of at least two reference image templates included in the search result with the image of the target object meet a first update condition is determined. In the case that the first update condition is met, a subset or all of the at least two reference image templates stored in the first database are updated. Increasing of a false recognition rate in recognition of the target object, which is caused by directly updating a search result after the search result is obtained, is avoided, and thus the accuracy of recognition based on the first database is improved.

A manner of updating the first database based on the acquired image of the target object is to directly store the image and/or information (such as feature data) of the image to the first database. However, it will result in that the number of templates in the first database may be increasing, resulting in that the data diffusion rate in the first database is overhigh.

In embodiments of the disclosure, before the first database is updated, whether the similarities of the at least two reference image templates with the image meet the first update condition is determined, and the first database is updated only if the first update condition is met, thereby reducing the probability that a plurality of image templates for a same object are stored in the database. In an application, a high data diffusion rate results in an increasing amount of data in the database (such as an increased number of templates). Subsequent retrieval will be inconvenient due to redundancy. Therefore, the database is updated in a timely manner in embodiments of the disclosure, so as to reduce the probability that a plurality of image templates for the same object is stored in the database.

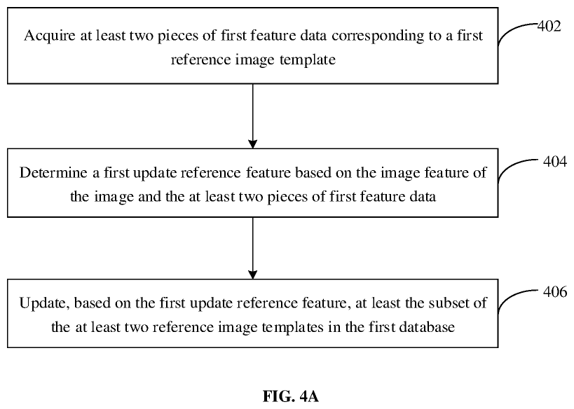

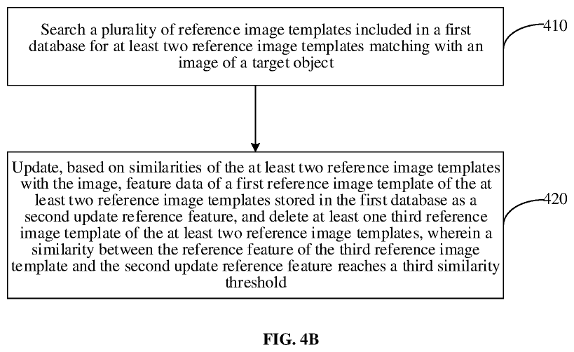

FIG. 4A illustrates a schematic flowchart of an optional example of updating at least a subset of at least two reference image templates stored in a first database in the method for updating a database according to an embodiment of the disclosure.

In operation 402, at least two pieces of first feature data corresponding to a first reference image template are acquired.

The first reference image template is a reference image template having a largest similarity with an image among the at least two reference image templates. A reference feature of the first reference image template is obtained based on the at least two pieces of first feature data corresponding to the first reference image template. The reference feature included in the first reference image template is obtained by averaging the at least two pieces of first feature data, such as mathematical averaging, weighted averaging or geometrical averaging. Alternatively, the reference feature included in the first reference image template is obtained by selecting from the at least two pieces of first feature data based on a specific criterion. The particular implementations of obtaining the reference feature included in the first reference image template based on the at least two pieces of first feature data corresponding to the first reference image template are not limited in the embodiments of the disclosure.

In operation 404, a first update reference feature is determined based on an image feature of an image and the at least two pieces of first feature data.

The first update reference feature is determined based on the at least two pieces of first feature data and the image feature. In some implementations, at least two pieces of feature data are selected from a set including the image feature of the image and the at least two pieces of first feature data, and the first update reference feature is determined based on the selected at least two pieces of feature data. In embodiments of the disclosure, the feature data may be selected in a variety of manners. For example, the image feature of the image and the at least two pieces of first feature data are averaged to obtain a first average feature, and at least two first update features are selected from a set including the image feature and the at least two pieces of first feature data based on respective distances from the image feature and the at least two pieces of first feature data to the first average feature. For example, at least two pieces of feature data (the image feature or the first feature data) closer to the first average feature are selected as the first update features. The at least two first update features are averaged to obtain the first update reference feature. Alternatively, the feature data may be selected in other manners, which is not limited in embodiments of the disclosure.

In operation 406, at least a subset of the at least two reference image templates stored in the first database are updated based on the first update reference feature.

In some implementations, a subset or all of the at least two reference image templates obtained by searching are adjusted based on the first update reference feature. For example, the reference feature included in the first reference image template of the at least two reference image templates is updated as the first update reference feature. For another example, a second update reference feature is obtained based on the first update reference feature, and the reference feature included in the first update reference feature is updated as the second update reference feature. For another example, a third update reference feature is obtained based on the first update reference feature, and a reference feature included in one or more second reference image templates of the at least two reference image templates other than the first reference image template is updated as the third update reference feature. In some other implementations, one or more third reference image templates of the at least two reference image templates other than the first reference image template are determined based on the first update reference feature, and the one or more third reference image templates are deleted from the first database. The particular implementations of updating the at least two reference image templates are not limited in the embodiments of the disclosure.

The operation 404 may include that: at least two first update features are selected from a set including the image feature of the image and the at least two pieces first feature data, and the first update reference feature is obtained based on the at least two first update features.

In some embodiments, the image feature of the image and the at least two pieces of first feature data are averaged to obtain a first average feature. Based on distances from the image feature of the image and the at least two pieces of first feature data to the first average feature, at least two pieces of feature data having smaller distances to the first average feature are selected as the first update features. For example, two features having minimum spatial distances to the average feature are selected as the first update features, and the first update reference feature is obtained based on the two first update features. For example, the first update reference feature is obtained by averaging, performing weighted averaging or the like on at least two first update features. The reference feature included in the first reference image template is obtained by averaging the at least two pieces of first feature data.

The operation that the first update reference feature is obtained based on the at least two first update features include that: the at least two first update features are averaged to obtain the first update reference feature. In embodiments of the disclosure, a reference feature is obtained by performing average processing on at least two pieces of first feature data that are obtained by extraction. The average processing may be superimposed averaging or weighted averaging. The particular manner of average processing is not limited in embodiments of the disclosure. In obtaining the first update reference feature, the at least two first update features are used equivalent to the at least two pieces of first feature data in obtaining the reference feature. That is to say, the average processing for obtaining the first update reference feature is the same as the average processing for obtaining the reference feature.

In some embodiments, the operation that the at least two first update features are selected from a set including the image feature of the first image and the at least two pieces of first feature data includes that: the image feature and the at least two pieces of first feature data are averaged to obtain a first average feature; and based on respective distances from the image feature and the at least two pieces of first feature data to the first average feature, the at least two first update features are selected from a set including the image feature and the at least two pieces of first feature data.

In embodiments of the disclosure, the first average feature obtained by averaging the image feature and the at least two pieces of first feature data is taken as a central point. Among the image feature and the at least two pieces of first feature data, at least two pieces of feature data (including the first feature data or the image feature) having the closest distances to the central point are determined to be the first update features.

In one or more optional embodiments, the operation 406 in the above embodiment includes that: the feature data of the first reference image template stored in the first database is updated as the first update reference feature. In embodiments of the disclosure, the feature data of the first reference image template is replaced by the first update reference feature for storage. As the first update reference feature is obtained in combination with the image feature and the image-based search result, update of the first reference image template stored in the first database is realized. The database can be adapted for identity recognition in different scenarios and changes of a target object with time, and thus the recognition accuracy of the target object is improved.

FIG. 4B illustrates a further schematic flowchart of the method for updating a database according to an embodiment of the disclosure.

In operation 410, a plurality of reference image templates included in a first database are searched for at least two reference image templates matching with an image of a target object.

For operation 410, reference can be made to operation 110 in the embodiment illustrated in FIG. 1.

In operation 420, feature data of a first reference image template of the at least two reference image templates stored in the first database is updated as a second update reference feature based on similarities of the at least two reference image templates with the image, and at least one third reference image template of the at least two reference image templates is deleted. A similarity between the at least one third reference image template and the second update reference feature reaches a third similarity threshold.

In operation 420, an approach for implementing operation 120 in the embodiment illustrated in FIG. 1 is provided.

In some embodiments, operation 420 may include the following operations.

In operation 4201, at least two pieces of first feature data corresponding to the first reference image template are acquired.

In operation 4202, a first update reference feature is determined based on the image feature of the image and the at least two pieces of first feature data.

In some implementations, at least two pieces of feature data are selected from a set including the image feature of the image and the at least two pieces of first feature data, and the first update reference feature is determined based on the selected at least two pieces of feature data.

In embodiments of the disclosure, the feature data may be selected in a variety of manners. For example, the image feature of the image and the at least two pieces of first feature data are averaged to obtain a first average feature, and at least two first update features are selected from a set including the image feature and the at least two pieces of first feature data, based on respective distances from the image feature and the at least two pieces of first feature data to the first average feature. For example, at least two pieces of feature data (the image feature or the first feature data) closer to the first average feature are selected to be first update features. The at least two first update features are averaged to obtain a first update reference feature. Alternatively, the feature data may also be selected in other manners, which is not limited in embodiments of the disclosure.

In operation 4203, one or more third reference image templates of the at least two reference image templates other than the first reference image template are determined based on the first update reference feature, and the one or more third reference image templates are deleted from the first database.

In operation 4204, at least two pieces of feature data are selected from a set including the one or more third reference image templates and the first reference image template, and a second update reference feature is determined based on the selected at least two pieces of feature data. The reference feature included in the first reference image template is updated as the second update reference feature.

In some embodiments, the method further includes: filtering at least one second reference image template of the at least two reference image templates other than the first reference image template, to obtain a filtering result, wherein the filtering result includes at least one third reference image template among the at least one second reference image template; and merging the at least one third reference image template included in the filtering result and the first reference image template, to obtain a merged image template.

In some embodiments, filtering the at least one second reference image template to obtain the filtering result includes: filtering, based on the first reference image template, the at least one second reference image template to obtain the filtering result.

In some embodiments, filtering, based on the first reference image template, the at least one second reference image template to obtain the filtering result includes: adding, to the filtering result, a second reference image template, of which a similarity with the first reference image template reaches a third similarity threshold, among the at least one second reference image template.

In some embodiments, filtering, based on the first reference image template, the at least one second reference image template to obtain the filtering result includes: obtaining a first update reference feature based on the first reference image template and the image of the target object; and filtering, based on a similarity of a reference feature included in the at least one second reference image template with the first update reference feature, the at least one second reference image template to obtain a filtering result.

In some embodiments, merging the at least one third reference image template included in the filtering result and the first reference image template, to obtain the merged image template includes: acquiring at least two pieces of second feature data corresponding to each of the at least one third reference image template and the first reference image template, wherein a reference feature included in the reference image template is obtained based on the at least two pieces of second feature data corresponding to the reference image template; and obtaining a second update reference feature based on the at least two pieces of second feature data corresponding to each of the at least one third reference image template and the first reference image template, wherein the second update reference feature is included in the merged image template.

In some embodiments, the method further includes: replacing, with the merged image template, the at least one third reference image template and the first reference image template in the first database.

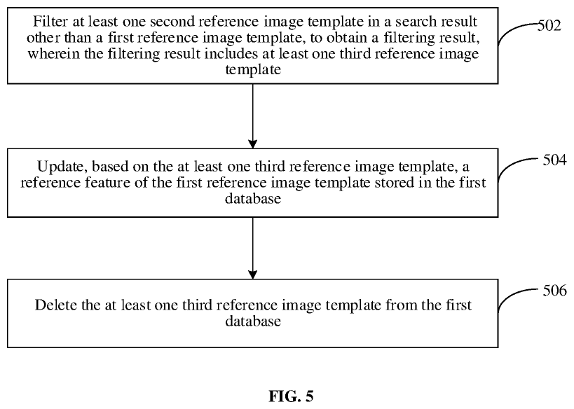

FIG. 5 illustrates a schematic flowchart of updating a first database in the method for updating a database according to an embodiment of the disclosure.

In operation 502, at least one second reference image template in a search result other than a first reference image template is filtered to obtain a filtering result. The filtering result includes at least one third reference image template.

The at least one second reference image template is filtered based on a similarity of the at least one second reference image template with the image of the target object. Alternatively, in the case where the number of the at least one second reference image template is more than one, the plurality of second reference image templates are filtered based on similarities among the plurality of second reference image templates. Alternatively, the at least one second reference image template is filtered based on the first reference image template. The at least one second reference image template may also be filtered in other manners. The particular implementations of filtering are not limited in the embodiments of the disclosure. In this way, reference image templates more likely to correspond to the same object are obtained by filtering. Further, the reference image templates that are more likely to correspond to the same object in the first database are merged, to reduce the diffusion rate of the first database.

In some possible implementations, the at least one second reference image template is filtered based on a first update reference feature to obtain a filtering result.

In some embodiments, at least one third reference image template of which a similarity with the first update reference feature meets a third update condition is selected from at least one second reference image template. The third update condition includes but not limited to: the similarity between the reference feature of a second reference image template the first update reference feature being greater than or equal to a third similarity threshold.

In embodiments of the disclosure, whether an obtained second reference image template is similar to the first update reference feature is determined based on the third update condition. For example, the third similarity threshold is greater than the first and/or second similarity threshold. If a similarity of the second reference image template with the first update reference feature is greater than or equal to the third similarity threshold, it indicates that the obtained second reference image template is largely similar to the first update reference feature. As the first update reference feature is obtained based on the first reference image template and the image feature, it may be considered that the third reference image template and the first reference image template are likely to the same target, and may be screened or merged to reduce the diffusion rate.

In operation 504, a reference feature of the first reference image template stored in the first database is updated based on the at least one third reference image template.

In operation 506, the at least one third reference image template is deleted from the first database.

In some possible implementations, reference features included in the at least one third reference image template and the reference feature included in the first reference image template are fused to obtain a fused feature, and the reference feature of the first reference image template is updated as the fused feature.

In some other possible implementations, a second update reference feature is obtained based on the at least one third reference image template included in the filtering result and the first reference image template, and the reference feature of the first reference image template is updated as the second updated reference feature.

The second update reference feature is determined based on the at least one third reference image template and the first reference image template.

In some implementations, at least two pieces of feature data are selected from a set including the at least one third reference image template and the first reference image template, and the second update reference feature is determined based on the selected at least two pieces of feature data.

In embodiments of the disclosure, the feature data may be selected in a variety of manners. For example, an average feature is obtained by performing averaging processing on the at least one third reference image template and the first reference image template. Based on distances from the at least one third reference image template and the first reference image template to the average feature, at least two reference image templates closer to the average feature are selected, from the at least one third reference image template and the first reference image template, to serve as second update features. The second update reference feature is obtained by processing the obtained at least two second update features, thus realizing merging of a plurality of reference image templates.

In some other possible implementations, at least a subset of the at least two reference image templates stored in the first database are updated based on the second update reference feature.

In some implementations, a subset or all of the at least two reference image templates obtained by searching are adjusted based on the second update reference feature. For example, the reference feature included in the first reference image template of the at least two reference image templates is updated as the second update reference feature. For another example, a third update reference feature is obtained based on the second update reference feature, and the reference feature included in one or more second reference image templates, of the at least two reference image templates other than the first reference image template, is updated as the third update reference feature.

In some other implementations, one or more third reference image templates, of the at least two reference image templates other than the first reference image template, are determined based on the second update reference feature, and the one or more third reference image templates are deleted from the first database. The particular implementations of updating the at least two reference image templates are not limited in embodiments of the disclosure.

In some embodiments, operation 504 includes that: at least two pieces of second feature data corresponding to each of the at least one third reference image templates are acquired; and the second update reference feature is obtained based on the at least two pieces of second feature data corresponding to each of the at least one third reference image template and the at least two pieces of first feature data.

The third reference image template is obtained by averaging the at least two pieces of second feature data. It may be considered that the second feature data is original data, and the third reference image template is average data obtained by averaging the original data. The at least two pieces of second feature data, and the at least two pieces of first feature data corresponding to the first reference image template are fused and screened, to obtain at least two pieces of feature data. Then, the obtained at least two pieces of feature data are averaged to obtain the second update feature data. For example, at least two second update features are selected from multiple pieces of second feature data corresponding to the at least one third reference image template and the at least two pieces of first feature data; and the second update reference feature is obtained based on the at least two second update features. For example, two pieces of second feature data corresponding to a third reference image template and two pieces of first feature data are fused and screened in a four-to-two manner, i.e., two of the four pieces of feature data are selected to serve as original data of a second update reference feature, and the original data is averaged to obtain the second update reference feature.

In some embodiments, the operation that the at least two second update features are selected from the multiple pieces of second feature data corresponding to the at least one third reference image template and the at least two pieces of first feature data may include that: a second average feature is determined based on the multiple pieces of second feature data corresponding to the at least one third reference image template and the at least two pieces of first feature data; and based on distances from the multiple pieces of second feature data corresponding to the at least one third reference image template and the at least two pieces of first feature data to the second average feature, the at least two second update features are selected from the multiple pieces of second feature data corresponding to the at least one third reference image template and the at least two pieces of first feature data.

In embodiments of the disclosure, a second average feature obtained by averaging a plurality of pieces of second feature data and at least two pieces of first feature data is taken as a central point. Distances from the second feature data and the first feature data to the second average feature are taken as spatial distances, to obtain at least two pieces of feature data having smaller distances to the central point to serve as second update features. Thus, screening of feature data is realized.

In embodiments of the disclosure, a first reference image template in a first database is replaced through a second update reference feature. At least one third reference image template and the first reference image template correspond to the same target. In order to reduce a diffusion rate in the first database, the at least one third reference image template is deleted from the first database.

In one or more optional embodiments, operation 402 in the above embodiment may include that: at least two pieces of first feature data corresponding to the first reference image template are acquired from a second database.

In embodiments of the disclosure, at least two pieces of first feature data correspond to one first reference image template. For example, each reference image template in the first database corresponds to at least two pieces of feature data. For the purpose of updating the first database more quickly, not all feature data is stored in the first database. In embodiments of the disclosure, the reference image template and the first feature data are stored in different databases respectively, so as to improve a processing speed. The first feature data is merely used during merging and fusion, and is thus stored in the second database alone. If the reference image template and the first feature data were stored together, the first database will be overlarge, and a processing speed will be slower.

In some implementations, the method for updating a database according to the embodiment illustrated in FIG. 3 further includes that: in response to determining that the similarities of the at least two reference image templates with the image meet a second update condition, a reference image template corresponding to the image is added to the first database.

In embodiments of the disclosure, the corresponding reference image template is established for the image in the first database through the second update condition. Image features corresponding to the image are original data, and are thus processed and added to the first database for storage. For example, the second update condition is that a maximum value of similarities of the at least two reference image templates with the image is smaller than a second similarity threshold. In some embodiments, average processing may be performed based on image features of at least two images corresponding to the target object, and feature data obtained after the average processing is stored to the first database.

In some embodiments, after the feature data is stored, a corresponding identity identification number may be further established for the feature data. Each piece of reference image template data in the first database corresponds to one identity identification number and one piece of feature data. The identity identification number (person_id) may serve as a unique identifier of the feature data. Each reference feature in the first database (the feature data, when stored in a dynamic first database, is also referred to as a reference feature) corresponds to one identity identification number, so it may be considered that each reference image template in the first database includes an identity identification number and a reference feature.

In some embodiments, the first update condition includes: a maximum value among the similarities of the at least two reference image templates with the image being greater than or equal to a second similarity threshold. In some embodiments, the second update condition includes: the maximum value among the similarities of the at least two reference image templates with the image being smaller than the second similarity threshold.

In some embodiments, the second similarity threshold is greater than the first similarity threshold. Whether the target object corresponding to the image has a corresponding reference feature template stored in the first database may be determined through the second similarity threshold. The second similarity threshold is configured to screen the reference image templates obtained by searching through the first similarity threshold. The second similarity threshold may be set to be greater than the first similarity threshold to ensure the accuracy of screening.

In some other implementations, each of the first update condition and the second update condition corresponds to a different similarity threshold. For example, the similarity threshold corresponding to the first update condition is greater than the similarity threshold corresponding to the second update condition, and the embodiments of the disclosure do not set limitations herein.

In an optional application example, two databases, namely a dynamic face database and an original database, are provided on a device. The dynamic face database corresponds to the first database in the above embodiments and stores a plurality of reference image templates, and each of the reference image templates includes a reference feature or an average feature. The original database corresponds to the second database in the above embodiments, and stores original feature data of the dynamic face database. Each reference image template corresponds to two or more original face features in the original database.

In the following example, it is assumed that the reference image template corresponds to two original face features in the original database, and the reference feature is obtained by averaging the two original face features. Besides, a correspondence between items, corresponding to the same person, in the dynamic face database and the original database is recorded.

In the following example, the items corresponding to the same person are identified in the two databases through a same identity identification number (person_id). In this way, original features corresponding to an average feature in the first database may be found in the second database based on the identity identification number.

An example of the updating process of the database is as follows.

1) A facial feature is extracted from an acquired image, and a dynamic face database is searched to obtain a search result. A template, of which a similarity with the acquired image reaches a first similarity threshold (threshold 1), in the dynamic face database is added to the search result;

2) A similarity between the first template in the search result (i.e., a template which has a maximum similarity with the acquired image) and the acquired image is compared with a second similarity threshold (threshold 2). If the similarity between the first template and the acquired image is smaller than the second similarity threshold, or the search result is null, template data corresponding to the acquired image is added to the dynamic face database and to an original database, and a correspondence between an identity identification number allocated to the first template and the face feature is stored to a person_feature mapping table;

3) If the similarity between the first template and the acquired image is greater than the second similarity threshold (threshold 2), anti-diffusion processing is performed;

4) Two original features corresponding to the first template are acquired from the original database, and an operation of selecting two from three is performed on the two original features and the facial feature of the acquired image, i.e., two features are selected from the acquired two original features and the facial feature, and the two features are averaged to obtain an average feature;

5) Similarities of subsequent k−1 templates in the search result other than the first template with the average feature are compared with a third similarity threshold (threshold 3) to obtain a filtering result. Specifically, a template among the k−1 templates that has a similarity with the average feature greater than the threshold 3 is added to a filtering result; and

6) The filtering result is traversed, an operation of selecting two from four is performed on the two features acquired in 4) and two original features corresponding to the template in the filtering result, and two facial features finally obtained are averaged to obtain an update feature. The update feature is used to perform feature update operation on the first template in the dynamic feature database, and information in the original database and the person_feature mapping table is updated.

It can be understood by those of ordinary skill in the art: all or part of the operations of the above method embodiments may be implemented by instructing related hardware through a program. The above program may be stored in a computer-readable storage medium. The, when executed, performs operations of the above method embodiments. The storage medium above includes various media capable of storing program codes such as a read-only memory (ROM), a random access memory (RAM), a magnetic disk or an optical disk.

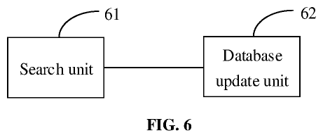

FIG. 6 is a schematic structural diagram of an apparatus for updating a database according to an embodiment of the disclosure. The apparatus may be configured to implement the above method embodiments in the disclosure. As illustrated in FIG. 6, the apparatus may include: a search unit 61 and a database update unit 62.

The search unit 61 is configured to search a plurality of reference image templates included in a first database for at least two reference image templates matching with an image of a target object. In embodiments of the disclosure, an image of a target object is acquired. For example, the image of the target object input by a user is received, or the image of the target object is acquired with an image sensor, or the image of the target object is received from other devices. The image of the target object may refer to an image containing at least a part of the target object, such as a face image, a half-length portrait or a body image. The image of the target object may be a static image or a video frame image. For example, the image of the target object may be a video frame image, such as an image frame in a video sequence originating from an image sensor, or may be a single image. The particular implementations of attributes, origins, means of acquisition or the like for the image of the target object are not limited in embodiments of the disclosure.

The database update unit 62 is configured to update the first database based on similarities of the at least two reference image templates with the image. According to the device for updating a database in the embodiments of the disclosure, a plurality of reference image templates included in a first database are searched for at least two reference image templates matching with an image of a target object; and the first database is updated based on similarities of the at least two reference image templates with the image, thereby improving system performance of the database.

In one or more optional embodiment, it is assumed that each reference image template includes a reference feature. The search unit 61 may include: a feature acquisition module, configured to acquire an image feature of the image of the target object; and a feature matching module, configured to search, based on similarities of the image feature with reference features of the plurality of reference image templates in the first database, the plurality of reference image templates for the at least two reference image templates matching with the image.

In embodiments of the disclosure, a reference image template includes a reference feature. Since feature data occupies less storage space than images, and feature extraction is not needed for the stored data during search, a search speed is increased, and the data processing efficiency is improved.

In some embodiments, the feature matching module is configured to determine, from the plurality of reference image templates, a reference image template having a reference feature of which a similarity with the image feature reaches a first similarity threshold, to be a reference image template matching with the image. In one or more optional embodiments, the database update unit 62 is configured to: in response to determining that the similarities of the at least two reference image templates with the image meet a first update condition, update, based on the image, at least a subset of the at least two reference image templates in the first database.

In embodiments of the disclosure, if at least one of the similarities of the at least two reference image templates with the image of the target object meets the first update condition, a subset or all of the at least two reference image templates included in a search result are updated based on the image of the target object. The update may refer to adjustment or deletion. For example, each of the at least two reference image templates included in the search result is updated based on the image of the target object, and the embodiments of the disclosure do not set limitations herein.

In some embodiments, the database update unit 62 is configured to: update, based on the similarities of the at least two reference image templates with the image, feature data of a first reference image template of the at least two reference image templates in the first database with a second update reference feature, and delete at least one third reference image template of the at least two reference image templates, wherein a similarity between the reference feature of the third reference image template and the second update reference feature reaches a third similarity threshold.

In some embodiments, the database update unit 62 may include a feature data module, a first determination module and a feature update module. The feature data module is configured to acquire at least two pieces of first feature data corresponding to a first reference image template. The first reference image template is a reference image template, having a maximum similarity with the image, of the at least two reference image templates, and a reference feature of the first reference image template is obtained based on the at least two pieces of first feature data. The first determination module is configured to determine a first update reference feature based on the image feature of the image and the at least two pieces of first feature data. The feature update module is configured to update, based on the first update reference feature, at least the subset of the at least two reference image templates in the first database

In some implementations, a subset or all of the at least two reference image templates obtained by searching are adjusted based on the first update reference feature. For example, the reference feature included in the first reference image template of the at least two reference image templates is updated as the first update reference feature. For another example, a second update reference feature is obtained based on the first update reference feature, and the reference feature included in the first update reference feature is updated as the second update reference feature. For another example, a third update reference feature is obtained based on the first update reference feature, and a reference feature included in one or more second reference image templates of the at least two reference image templates other than the first reference image template is updated as the third update reference feature. In some other implementations, one or more third reference image templates of the at least two reference image templates other than the first reference image template are determined based on the first update reference feature, and the one or more third reference image templates are deleted from the first database. The particular implementations of updating the at least two reference image templates are not limited in the embodiments of the disclosure.

In some embodiments, the first determination module is configured to select, from the image feature of the image and the at least two first feature data, at least two first update features; and obtain the first update reference feature based on the at least two first update features.

In some embodiments, the reference feature included in the first reference image template is obtained by averaging the at least two pieces of first feature data; and the first determination module is configured to average the at least two pieces of first feature data to obtain the first update reference feature.

In some embodiments, the first determination module is configured to average the image feature and the at least two pieces of first feature data to obtain a first average feature; and select, based on respective distances from the image feature and the at least two pieces of first feature data to the first average feature, the at least two first update features from the image feature and the at least two first feature data.

In some embodiments, the feature update module is configured to update the feature data of the first reference image template stored in the first database with the first update reference feature.

In some embodiments, the feature update module includes a similarity selection module, a second determination module and feature update sub-module. The similarity selection module, configured to select, from at least one second reference image template, at least one third reference image template, having a reference feature of which a similarity with the first update reference feature meets a third update condition, the at least one second reference image template being among the at least two second reference image templates other than the first reference image template. The second determination module is configured to obtain, based on the at least one third reference image template and the first reference image template, a second update reference feature. The feature update sub-module is configured to update, based on the second update reference feature, at least the subset of the at least two reference image templates in the first database

In some embodiments, the third update condition includes: the similarity between the reference feature of a second reference image template and the first update reference feature being greater than or equal to a third similarity threshold.

In some embodiments, the second determination module is configured to: acquire at least two pieces of second feature data corresponding to each of the at least one third reference image template; and obtain, based on the at least two pieces of second feature data corresponding to each of the at least one third reference image template and the at least two pieces of first feature data, the second update reference feature.

In some embodiments, the second determination module is configured to: select, from multiple pieces of second feature data corresponding to the at least one third reference image template and the at least two pieces of first feature data, at least two second update features; and obtain the second update reference feature based on the at least two second update features.

In some embodiments, in selecting, from the multiple pieces of second feature data corresponding to the at least one third reference image template and the at least two pieces of first feature data, the at least two second update features, the second determination module is configured to: determine, based on the multiple pieces of second feature data corresponding to the at least one third reference image template and the at least two pieces of first feature data, a second average feature; and select, based on distances from the multiple pieces of second feature data corresponding to the at least one third reference image template and the at least two pieces of first feature data to the second average feature, the at least two second update features from the multiple pieces of second feature data corresponding to the at least one third reference image template and the at least two pieces of first feature data.

In some embodiments, the feature update sub-module is configured to update feature data of the first reference image template in the first database with the second update reference feature.

In some embodiments, the feature update module may further include: a deletion module, configured to delete the at least one third reference image template from the first database.

In some embodiments, the feature data module is configured to acquire, from a second database, the at least two pieces of first feature data corresponding to the first reference image template.

In some embodiments, the database update unit is further configured to: in response to determining that the similarities of the at least two reference image templates with the image meet a second update condition, add a reference image template corresponding to the image to the first database.

In some embodiments, the first update condition includes: a maximum value among the similarities of the at least two reference image templates with the image being greater than or equal to a second similarity threshold; and/or, the second update condition includes: the maximum value among the similarities of the at least two reference image templates with the image being smaller than the second similarity threshold.

In some embodiments, the second similarity threshold is greater than the first similarity threshold.

According to another aspect of the embodiments of the disclosure, an electronic device is provided, which may include a processor including the apparatus for updating a database in any above embodiment.

According to still another aspect of the embodiments of the disclosure, an electronic device is provided, which may include: a memory, configured to store executable instructions; and a processor, configured to communicate with the memory to execute the executable instructions to implement operations of the method for updating a database provided in any above embodiment.

According to another aspect of the embodiments of the disclosure, provided is a computer-readable storage medium configured to store computer-readable instructions, that when being executed, carry out operations of the method for updating a database provided in any above embodiment.

According to another aspect of the embodiments of the disclosure, provided is a computer program product including computer-readable codes that, when running on a device, cause a processor in the device to execute instructions for implementing the method for updating a database provided in any above embodiment.

According to still another aspect of the embodiments of the disclosure, provided is another computer program product configured to store computer-readable instructions which, when being executed, causes a computer to execute operations of the method for updating a database provided in any above embodiment. The computer program product may be specifically implemented through hardware, software or a combination thereof. In an optional example, the computer program product is specifically embodied as a computer storage medium; and in another example, the computer program product is specifically embodied as a software product, such as a software development kit (SDK).

According to the embodiments of the disclosure, a method and apparatus for updating a database, an electronic device, a computer storage medium and a computer program product are further provided. A plurality of reference image templates included in a first database are searched for at least two reference image templates matching with an image of a target object; and the first database is updated based on similarities of the at least two reference image templates with the image.

Based on the method and apparatus for updating a database, the electronic device, the computer storage medium and the computer program product provided in the above embodiments of the disclosure, a plurality of reference image templates in a first database are searched for at least two reference image templates matching with an image of a target object; and the first database is updated based on similarities of the at least two reference image templates with the image. System performance of the database is effectively improved.

In some embodiments, a network acquisition instruction or an image processing instruction may be an invoking instruction specifically. A first apparatus may instruct, by invoking, a second apparatus to perform network acquisition or image processing. Correspondingly, in response to receiving the invoking instruction, the second apparatus may execute steps and/or procedures in any embodiment of the method for updating a database.

It is to be understood that terms “first”, “second” and the like In embodiments of the disclosure are only for distinguishing and should not be construed as limits to the embodiment of the application. It is also to be understood that, in the disclosure, “multiple/a plurality of” may refer to two or more than two, and “at least one” may refer to one, two, or more than two. It is also to be understood that, any component, data or structure mentioned in the disclosure may be understood to be one or more if it is not clearly specified or there is no opposite indication given in the context. It is also to be understood that, in the disclosure, the descriptions about each embodiments are made with emphasis on differences among the embodiments, and reference can be made to one another for the same or similar parts. Description will not be made here for simplicity.

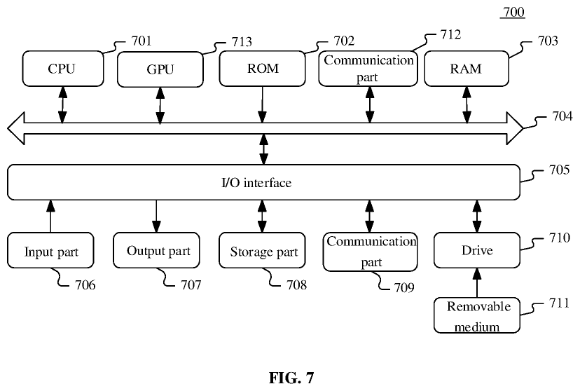

In embodiments of the disclosure, further provided is an electronic device, which may be, for example, a mobile terminal, a Personal Computer (PC), a tablet computer, and a server. Referring to FIG. 7 below, a structural schematic diagram of an electronic device 700 according to an embodiment of the application is illustrated.

As illustrated in FIG. 7, the electronic device 700 includes one or more processors, a communication part and the like. The one or more processors may be one or more Central Processing Units (CPUs) 701 and/or one or more Graphics Processing Units (GPUs) 713, etc. The processor may execute various proper operations and processing according to executable instructions stored in a read-only memory (ROM) 702 or executable instructions loaded from a storage part 708 to a random access memory (RAM) 703. The communication part 712 may include, but not limited to, a network card, and the network card may include, but not limited to, an Infiniband (IB) network card.

The processor may communicate with the ROM 702 and/or the RAM 703 to execute the executable instruction, is connected with the communication part 712 through a bus 704 and communicates with another target device through the communication unit 712, thereby completing the corresponding operations of any method provided in the embodiments of the disclosure. An example of the operations may include that: a plurality of reference image templates included in a first database are searched for at least two reference image templates matching with an image of a target object; and the first database is updated based on similarities of the at least two reference image templates with the image. In addition, various programs and data required by operation of the apparatus may further be stored in the RAM 703. The CPU 701, the ROM 702 and the RAM 703 are connected with one another through a bus 704. With existence of the RAM 703, the ROM 702 is an optional module. The RAM 703 stores executable instructions, or writes the executable instructions to the ROM 702 during running. The executable instructions enable the CPU 701 to execute the corresponding operations of the method for updating a database. An Input/Output (I/O) interface 705 is also connected to the bus 704. The communication part 712 may be arranged in an integrated manner, and may also be arranged to include multiple submodules (for example, multiple IB network cards) on a bus link.

The following components are connected to the I/O interface 705: an input part 706, such as a keyboard or a mouse; an output part 707 such as a Cathode-Ray Tube (CRT), a Liquid Crystal Display (LCD), or a loudspeaker; a storage part 708 such as a hard disk; and a communication part 709 such as a Local Area Network (LAN) card, or a network interface card of a modem. The communication part 709 executes communication processing through a network such as the Internet. A driver 710 is also connected to the I/O interface 705 as required. A removable medium 711, for example, a magnetic disk, an optical disk, a magneto-optical disk and a semiconductor memory, is installed on the driver 710 as required such that a computer program read therefrom is installed in the storage part 708 as required.

It is to be noted that the architecture illustrated in FIG. 7 is only an optional implementation. The number and types of the components in FIG. 7 may be selected, omitted, added or replaced according to a practical requirement in a practical process. Different functional components may be arranged separately or in an integrated manner. For example, the GPU 713 and the CPU 701 may be separately arranged, or the GPU 713 may be integrated on the CPU 701. The communication part may be separately arranged or may be integrated to the CPU 701 or the GPU 713. All these alternative implementations shall fall within the scope of protection of the disclosure.

Particularly, according to the embodiment of the disclosure, the process described above with reference to the flowchart may be implemented as a computer software program. For example, a computer program product including a computer program tangibly included in a machine-readable medium is provided in embodiments of the disclosure. The computer program. The computer program includes program codes configured to execute the method illustrated in the flowchart. The program codes may include corresponding instructions for executing the operations in the method provided in embodiments of the disclosure. An example of the operations include that: a plurality of reference image templates included in a first database are searched for at least two reference image templates matching with an image of a target object; and the first database is updated based on similarities of the at least two reference image templates with the image. In such an embodiment, the computer program may be installed after being downloaded from the network through the communication part 709, and/or installed from the removable medium 711. The computer program, when executed by the CPU 701, performs operations of the above functions defined in the method of the disclosure.

The method and apparatus of the disclosure may be implemented in various manners. For example, the method and apparatus of the disclosure may be implemented through software, hardware, firmware, or any combination of software, hardware and firmware. The sequence of the operations of the method is only for description, and the operations of the method of the disclosure are not limited to the sequence specifically described above, unless otherwise specified in another way. In addition, in some embodiments, the disclosure may also be implemented as a program recorded in a recording medium, and the program includes machine-readable instructions configured to implement the method according to the disclosure. Therefore, the disclosure further cover a recording medium for storing the program configured to execute the method according to the disclosure.

The description of the disclosure is made for an exemplary and descriptive purpose, and is not intended to be exhaustive or limit the application to the disclosed form. Many modifications and variations are apparent to those of ordinary skill in the art. The embodiments are selected and described to describe the principle and practical application of the application better and enable those of ordinary skill in the art to understand the application and further design various embodiments that are suitable for specific purposes and carry various modifications.

1. A computer-implemented method for updating a database, comprising:
searching a plurality of reference image templates in a first database for at least two reference image templates matching with an image of a target object; and
updating the first database based on similarities of the at least two reference image templates with the image.

2. The computer-implemented method of claim 1, wherein each of the plurality of reference image templates comprises a reference feature; and
wherein searching the plurality of reference image templates in the first database for the at least two reference image templates matching with the image of the target object comprises:
acquiring an image feature of the image of the target object; and
searching, based on similarities of the image feature with reference features of the plurality of reference image templates in the first database, the plurality of reference image templates for the at least two reference image templates matching with the image.

3. The computer-implemented method of claim 1, wherein updating the first database based on the similarities of the at least two reference image templates with the image comprises:
updating, based on the similarities of the at least two reference image templates with the image, feature data of a first reference image template of the at least two reference image templates in the first database with a second update reference feature, and deleting at least one third reference image template of the at least two reference image templates, wherein a similarity between the reference feature of the third reference image template and the second update reference feature reaches a third similarity threshold.

4. The computer-implemented method of claim 1, wherein updating the first database based on the similarities of the at least two reference image templates with the image comprises:
in response to determining that the similarities of the at least two reference image templates with the image meet a first update condition, updating, based on the image, at least a subset of the at least two reference image templates in the first database.

5. The computer-implemented method of claim 4, wherein updating, based on the image, at least the subset of the at least two reference image templates in the first database comprises:
acquiring at least two pieces of first feature data corresponding to a first reference image template, wherein the first reference image template is a reference image template which has a maximum similarity with the image among the at least two reference image templates, and a reference feature of the first reference image template is obtained based on the at least two pieces of first feature data;
determining a first update reference feature based on an image feature of the image and the at least two pieces of first feature data; and
updating, based on the first update reference feature, at least the subset of the at least two reference image templates in the first database.

6. The computer-implemented method of claim 5, wherein determining the first update reference feature based on the image feature of the image and the at least two pieces of first feature data comprises:
selecting, from the image feature of the image and the at least two pieces of first feature data, at least two first update features; and
obtaining the first update reference feature based on the at least two first update features.

7. The computer-implemented method of claim 6, wherein the reference feature of the first reference image template is obtained by averaging the at least two pieces of first feature data; and
obtaining the first update reference feature based on the at least two first update features comprises:
averaging the at least two first update features to obtain the first update reference feature.

8. The computer-implemented method of claim 6, wherein selecting, from the image feature of the image and the at least two pieces of first feature data, the at least two first update features comprises:
averaging the image feature and the at least two pieces of first feature data to obtain a first average feature; and
selecting, based on distances from the image feature and the at least two pieces of first feature data to the first average feature, the at least two first update features from the image feature and the at least two pieces of first feature data.

9. The computer-implemented method of claim 5, wherein updating, based on the first update reference feature, at least the subset of the at least two reference image templates in the first database comprises:
updating feature data of the first reference image template in the first database with the first update reference feature.

10. The computer-implemented method of claim 5, wherein updating, based on the first update reference feature, at least the subset of the at least two reference image templates in the first database comprises:
selecting, from at least one second reference image template, at least one third reference image template, having a reference feature of which a similarity with the first update reference feature meets a third update condition, the at least one second reference image template being among the at least two second reference image templates other than the first reference image template;
obtaining, based on the at least one third reference image template and the first reference image template, a second update reference feature; and
updating, based on the second update reference feature, at least the subset of the at least two reference image templates in the first database.

11. The computer-implemented method of claim 10, wherein obtaining, based on the at least one third reference image template and the first reference image template, the second update reference feature comprises:
acquiring at least two pieces of second feature data corresponding to each of the at least one third reference image template; and
obtaining, based on the at least two pieces of second feature data corresponding to each of the at least one third reference image template and the at least two pieces of first feature data, the second update reference feature.

12. The computer-implemented method of claim 11, wherein obtaining, based on the at least two pieces of second feature data corresponding to each of the at least one third reference image template and the at least two pieces of first feature data, the second update reference feature comprises:
selecting, from multiple pieces of second feature data corresponding to the at least one third reference image template and the at least two pieces of first feature data, at least two second update features; and
obtaining the second update reference feature based on the at least two second update features.

13. The computer-implemented method of claim 12, wherein selecting, from the multiple pieces of second feature data corresponding to the at least one third reference image template and the at least two pieces of first feature data, the at least two second update features comprises:
determining, based on the multiple pieces of second feature data corresponding to the at least one third reference image template and the at least two pieces of first feature data, a second average feature; and
selecting, based on distances from the multiple pieces of second feature data corresponding to the at least one third reference image template and the at least two pieces of first feature data to the second average feature, the at least two second update features from the multiple pieces of second feature data corresponding to the at least one third reference image template and the at least two pieces of first feature data.

14. The computer-implemented method of claim 10, wherein updating, based on the second update reference feature, at least the subset of the at least two reference image templates in the first database comprises:
updating feature data of the first reference image template in the first database as the second update reference feature.

15. The computer-implemented method of claim 10, further comprising:
deleting the at least one third reference image template from the first database.

16. The computer-implemented method of claim 5, wherein acquiring the at least two pieces of first feature data corresponding to the first reference image template comprises:
acquiring, from a second database, the at least two pieces of first feature data corresponding to the first reference image template.

17. The computer-implemented method of claim 4, further comprising:
in response to determining that the similarities of the at least two reference image templates with the image meet a second update condition, adding a reference image template corresponding to the image to the first database.

18. The computer-implemented method of claim 17, wherein:
the first update condition comprises: a maximum value among the similarities of the at least two reference image templates with the image being greater than or equal to a second similarity threshold, and/or the second update condition comprises: the maximum value among the similarities of the at least two reference image templates with the image being smaller than the second similarity threshold;
wherein the second similarity threshold is greater than a first similarity threshold that is used for searching for the at least two reference image templates matching with the image of the target object.

19. An apparatus for updating a database, comprising:
a processor; and
a memory configured to store instructions which, when being executed by the processor, cause the processor to carry out the following:
searching a plurality of reference image templates in a first database for at least two reference image templates matching with an image of a target object; and
updating the first database based on similarities of the at least two reference image templates with the image.

20. A non-transitory computer-readable storage medium having stored thereon computer programs that, when being executed by a computer, cause the computer to carry out the following:
searching a plurality of reference image templates in a first database for at least two reference image templates matching with an image of a target object; and
updating the first database based on similarities of the at least two reference image templates with the image.
